(19) United States
(12) Patent Application Publication
(10) Pub. No.: US 2013/0002074 A1
(43) Pub. Date: Jan. 3, 2013

(54) Modularized Electromagnetic Resistance Apparatus

(76) Inventor: Shih-Jung Wang, Taiping City (TW)

(21) Appl. No.: 13/171,722

(22) Filed: Jun. 29, 2011

(51) Int. Cl. H02K 49/04

(52) U.S. Cl. 310/99; 310/105

(57) ABSTRACT

An electromagnetic resistance apparatus includes a magnetically controlled mechanism. The magnetically controlled mechanism includes a spool, a coil wound around the spool, two magnetic units connected with the spool, and a clearance defined between the two magnetic units and aligning with the coil. Thus, the coil is directly wound around the spool, the magnetic plates laminate each other to form each of the two magnetic units, and the two magnetic units are directly combined with the spool, so that the magnetically controlled mechanism is assembled easily and quickly so as to shorten the time and save the cost of assembly of the electromagnetic resistance apparatus.

### BACKGROUND OF THE INVENTION

1. Field of the Invention

The present invention relates to a damping system and, more particularly, to an electromagnetic resistance apparatus for a rehabilitation or exercising equipment.

2. Description of the Related Art

A conventional electromagnetic resistance apparatus comprises a fixing frame mounted on a rehabilitation or exercising equipment, an inertia wheel pivotally mounted on the fixing frame, a magnetically controlled braking ring secured on a periphery of the inertia wheel, and a magnetic body secured on the fixing frame and aligning with the inertia wheel. The magnetic body includes a magnetic circuit which having at least two poles, and a plurality of coils wound around each of the poles of the magnetic circuit. Thus, when the coils are energized, the magnetic body produces a magnetic force to provide a resistance to damp rotation of the inertia wheel so that the user has to apply a larger force on the inertia wheel so as to overcome the damping force or resistance applied by the magnetic body, thereby enhancing the exercising or rehabilitating effect. The rehabilitation or exercising equipment has a controller to control the voltage, current and output magnetic power of the coils so as to control the magnetic flux in the magnetic circuit so that the damping force or resistance can be regulated properly. However, the coils are limited to the profile of the magnetic body so that the coils are initially extended into a gap of the magnetic body slowly and are then in turn wound around the magnetic body. Thus, it takes a longer time to assemble the magnetic body and the coils, thereby causing inconvenience and wasting time in assembly of the electromagnetic resistance apparatus.

### BRIEF SUMMARY OF THE INVENTION

In accordance with the present invention, there is provided an electromagnetic resistance apparatus, comprising a magnetically controlled mechanism. The magnetically controlled mechanism includes a spool, a coil wound around the spool, two magnetic units connected with the spool, and a clearance defined between the two magnetic units and aligning with the coil.

The primary objective of the present invention is to provide an electromagnetic resistance apparatus with a modularized structure.

According to the primary advantage of the present invention, the coil is directly wound around the spool, the magnetic plates laminate each other to form each of the two magnetic units, and the two magnetic units are directly combined with the spool, so that the magnetically controlled mechanism is assembled easily and quickly so as to shorten the time and save the cost of assembly of the electromagnetic resistance apparatus.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a magnetically controlled mechanism of an electromagnetic resistance apparatus in accordance with the preferred embodiment of the present invention.

FIG. 2 is an exploded perspective view of the magnetically controlled mechanism of the electromagnetic resistance apparatus as shown in FIG. 1.

FIG. 3 is a top cross-sectional view of the magnetically controlled mechanism of the electromagnetic resistance apparatus as shown in FIG. 1.

FIG. 4 is a perspective view of the electromagnetic resistance apparatus in accordance with the preferred embodiment of the present invention.

### DETAILED DESCRIPTION OF THE INVENTION

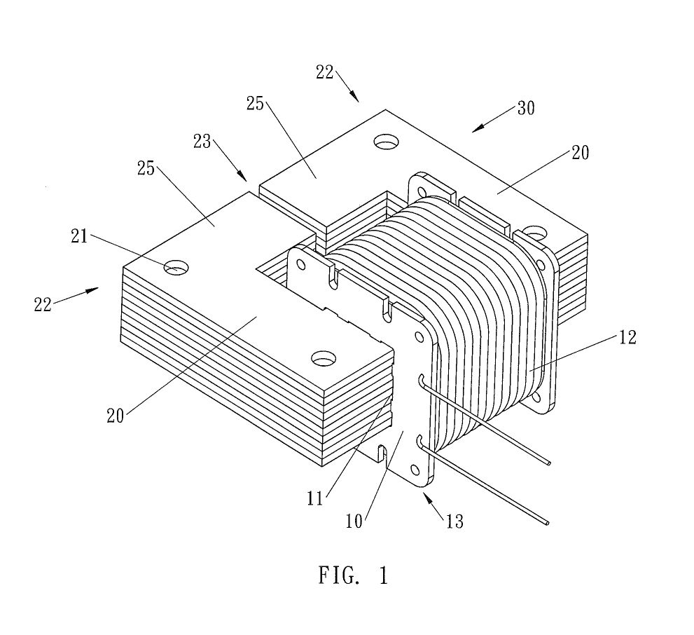

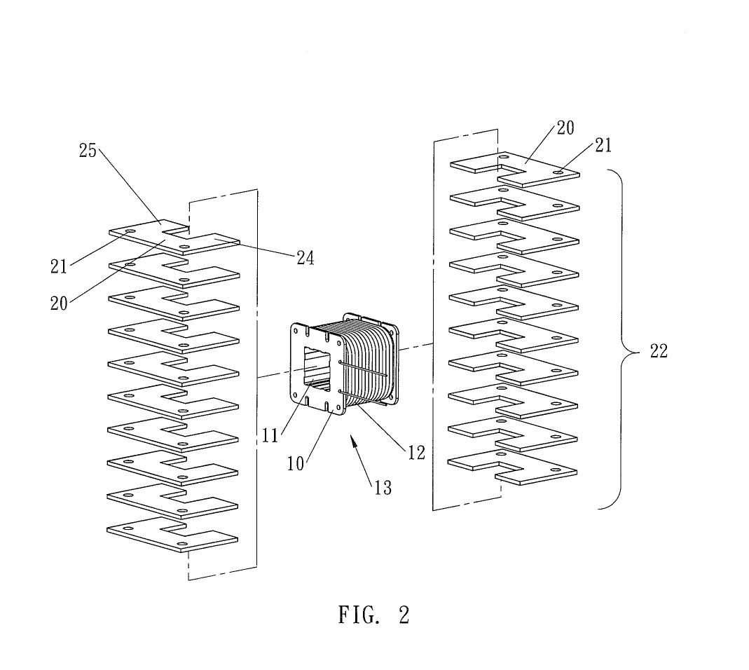

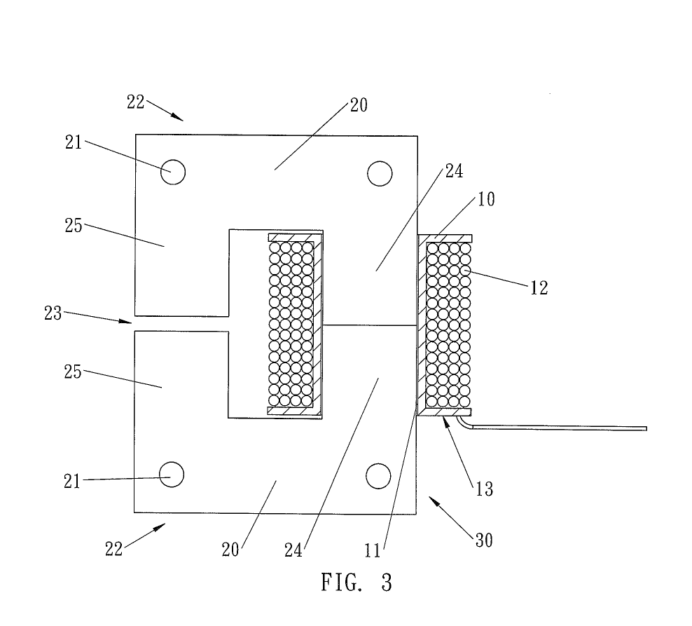

Referring to FIGS. 1-4, an electromagnetic resistance apparatus in accordance with the preferred embodiment of the present invention comprises a magnetically controlled mechanism 30.

The magnetically controlled mechanism 30 includes a spool 13, a coil 12 wound around the spool 13, two magnetic units 22 connected with the spool 13, and a clearance 23 defined between the two magnetic units 22 and aligning with the coil 12.

The spool 13 of the magnetically controlled mechanism 30 is made of a plastic material. The spool 13 of the magnetically controlled mechanism 30 has a square shape and has an interior provided with a receiving chamber 11. The spool 13 of the magnetically controlled mechanism 30 has a peripheral wall provided with two opposite stop flanges 10. The coil 12 of the magnetically controlled mechanism 30 is limited between the two stop flanges 10 of the spool 13.

Each of the two magnetic units 22 of the magnetically controlled mechanism 30 has a substantially U-shaped profile and has a first end 24 inserted into the receiving chamber 11 of the spool 13 and a second end 25 located outside of the spool 13. The first ends 24 of the two magnetic units 22 have opposite poles and are juxtaposed to each other. The second ends 25 of the two magnetic units 22 are spaced from and faces each other, and the clearance 23 of the magnetically controlled mechanism 30 is defined between the second ends 25 of the two magnetic units 22.

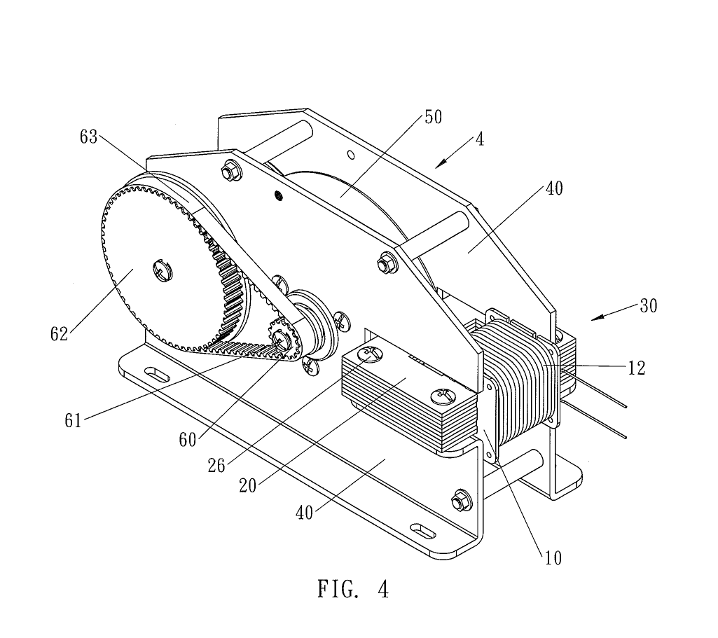

Each of the two magnetic units 22 of the magnetically controlled mechanism 30 includes a plurality of magnetic plates 20 laminating each other. Each of the magnetic plates 20 of each of the two magnetic units 22 is made of silicon steel and has a surface provided with a plurality of fixing holes 21. The magnetic plates 20 of each of the two magnetic units 22 are combined together by a plurality of fastening members 26 (see FIG. 4) which are extended through the fixing holes 21 of each of the magnetic plates 20.

In assembly, the coil 12 is directly wound around the spool 13. Then, the magnetic plates 20 laminate each other and are combined together by the fastening members 26 to form each of the two magnetic units 22. Then, the two magnetic units 22 are directly inserted into and combined with the spool 13, so that the magnetically controlled mechanism 30 is assembled.

The electromagnetic resistance apparatus further comprises a support frame 4 for mounting the magnetically controlled mechanism 30, a mandrel 61 rotatably mounted on the support frame 4, a metallic inertia wheel 50 secured on the mandrel 61 to rotate in concert with the mandrel 61 and aligning with the magnetically controlled mechanism 30, a first geared member 60 secured on the mandrel 61 to rotate in concert with the mandrel 61, a second geared member 62 rotatably mounted on the support frame 4, and a toothed belt 63 mounted between and meshing with the first geared member 60 and the second geared member 62 so that the first geared member 60 and the second geared member 62 are rotated in concert with each other.

The support frame 4 includes two support brackets 40 spaced from each other to support the magnetically controlled mechanism 30. The inertia wheel 50 is extended through the clearance 23 of the magnetically controlled mechanism 30 and is aligned with the coil 12 of the magnetically controlled mechanism 30.

In operation, when the second geared member 62 is driven by a transmission mechanism (not shown) which is driven by a user, the second geared member 62 is rotated to drive the toothed belt 63 which rotates the first geared member 60 which rotates the mandrel 61 which rotates the inertia wheel 50 so that the inertia wheel 50 can be rotated in the clearance 23 of the magnetically controlled mechanism 30. When the magnetically controlled mechanism 30 is energized, the coil 12 and the magnetic units 22 of the magnetically controlled mechanism 30 produce an electromagnetic effect and provide a resistance to damp rotation of the inertia wheel 50 so that the user has to apply a larger force to drive the inertia wheel 50 so as to overcome the damping force applied by the magnetically controlled mechanism 30, thereby enhancing the exercising or rehabilitating effect.

Accordingly, the coil 12 is directly wound around the spool 13, the magnetic plates 20 laminate each other to form each of the two magnetic units 22, and the two magnetic units 22 are directly combined with the spool 13, so that the magnetically controlled mechanism 30 is assembled easily and quickly so as to shorten the time and save the cost of assembly of the electromagnetic resistance apparatus.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An electromagnetic resistance apparatus, comprising:
a magnetically controlled mechanism including:
a spool;
a coil wound around the spool;
two magnetic units connected with the spool; and
a clearance defined between the two magnetic units and aligning with the coil.

2. The electromagnetic resistance apparatus of claim 1, wherein
the spool of the magnetically controlled mechanism has an interior provided with a receiving chamber;
each of the two magnetic units of the magnetically controlled mechanism has a first end inserted into the receiving chamber of the spool and a second end located outside of the spool;
the second ends of the two magnetic units are spaced from and faces each other;
the clearance of the magnetically controlled mechanism is defined between the second ends of the two magnetic units.

3. The electromagnetic resistance apparatus of claim 2, wherein the first ends of the two magnetic units have opposite poles and are juxtaposed to each other.

4. The electromagnetic resistance apparatus of claim 2, wherein each of the two magnetic units of the magnetically controlled mechanism has a substantially U-shaped profile.

5. The electromagnetic resistance apparatus of claim 1, wherein
the spool of the magnetically controlled mechanism has a peripheral wall provided with two opposite stop flanges;
the coil of the magnetically controlled mechanism is limited between the two stop flanges of the spool.

6. The electromagnetic resistance apparatus of claim 1, wherein each of the two magnetic units of the magnetically controlled mechanism includes a plurality of magnetic plates laminating each other.

7. The electromagnetic resistance apparatus of claim 6, wherein each of the magnetic plates of each of the two magnetic units has a surface provided with a plurality of fixing holes.

8. The electromagnetic resistance apparatus of claim 7, wherein the magnetic plates of each of the two magnetic units are combined together by a plurality of fastening members which are extended through the fixing holes of each of the magnetic plates.

9. The electromagnetic resistance apparatus of claim 2, wherein the spool of the magnetically controlled mechanism has a square shape.

10. The electromagnetic resistance apparatus of claim 1, wherein the spool of the magnetically controlled mechanism is made of a plastic material.

11. The electromagnetic resistance apparatus of claim 6, wherein each of the magnetic plates of each of the two magnetic units is made of silicon steel.

12. The electromagnetic resistance apparatus of claim 1, wherein the electromagnetic resistance apparatus further comprises:
a support frame for mounting the magnetically controlled mechanism;
a mandrel rotatably mounted on the support frame;
a metallic inertia wheel secured on the mandrel to rotate in concert with the mandrel and aligning with the magnetically controlled mechanism;
a first geared member secured on the mandrel to rotate in concert with the mandrel;
a second geared member rotatably mounted on the support frame; and
a toothed belt mounted between and meshing with the first geared member and the second geared member so that the first geared member and the second geared member are rotated in concert with each other.

13. The electromagnetic resistance apparatus of claim 12, wherein the support frame includes two support brackets spaced from each other to support the magnetically controlled mechanism.

14. The electromagnetic resistance apparatus of claim 12, wherein the inertia wheel is extended through the clearance of the magnetically controlled mechanism and is aligned with the coil of the magnetically controlled mechanism.
